(19) United States
(12) Patent Application Publication
(10) Pub. No.: US 2006/0164245 A1
(43) Pub. Date: Jul. 27, 2006

(54) Equipment configuration visualization tools, systems and methods

(75) Inventor: Thomas Henry Kibalo, Annapolis, MD (US)

Correspondence Address: HENRICKS SLAVIN AND HOLMES LLP;SUITE 200, 840 APOLLO STREET, EL SEGUNDO, CA, 90245, US

(73) Assignee: The Aerospace Corporation

(21) Appl. No.: 11/036,817

(22) Filed: Jan. 15, 2005

(51) Int. Cl. G08B 13/14; G06Q 30/00

(52) U.S. Cl. 340/572.1; 235/385

(57) ABSTRACT

An equipment configuration visualization apparatus includes a visualization tool configured to integrate a network of electronic tagging devices that are directly and/or remotely interfaced with the visualization tool. The electronic tagging devices store information associated with equipment. The visualization tool is configured to poll the electronic tagging devices to obtain the information and to generate visual representations from the information.

### TECHNICAL FIELD

The invention relates generally to inventory systems and, in particular, to equipment configuration visualization tools, systems and methods.

### BACKGROUND ART

Electronic tagging technologies are normally associated with personnel tracking, shipments, equipment inventory, calibration, and accounting paradigms within large corporations. However, known electronic tagging approaches do not always specifically address the domain and needs of facilities operation rack builds, configurations and equipment utilization. By way of example, current electronic tagging technologies do not meet the needs of many government laboratory based operations. Equipment within such laboratories is a shared resource that is in high demand by a broad range of personnel and applications. The total resource is often many millions of dollars of equipment consisting of hundreds of different and sometimes unique types of equipment. Because of this and the high volume of associated laboratory activities, the existing accounting cycles are lengthy and the manpower demands are intensive. The paper trails are inefficient and often ignored during urgent crisis situations. Equipment Configuration Personnel often have to resort to physical audits and then manual realignment of these audits with an off-line Inventory Database. Some electronic tagging approaches depend upon disparate access to multiple off-line databases for obtaining equipment specific information and/or manual retrieval of basic rack configuration and layout data.

It would be useful to be able to address one or more of the above deficiencies, as well to provide a user with timely and user-friendly access to equipment locations, utilization, and composition information, as well as other information. It would also be useful to be able to provide equipment configuration visualization tools, systems, and methods that address such needs. It would also be useful to be able to provide equipment configuration visualization tools, systems, and methods that utilize inexpensive, e.g., commercial off the shelf (COTS), components.

### BRIEF DESCRIPTION OF THE DRAWINGS

FIG. 1 illustrates an example embodiment of an equipment configuration visualization system;

FIG. 2 illustrates an example Visualization Tool Unified Modeling Language (UML) Use Case;

FIG. 3 illustrates an example Visualization Tool UML Collaboration Diagram;

FIG. 4A illustrates components of an example I-Button network;

FIG. 4B illustrates an example I-Button fixture, with its modular connector and an I-Button in a battery holder shown in perspective;

FIG. 4C illustrates how the I-Button fixture of FIG. 4B can be interconnected to other local Buttons or to a coupler;

FIG. 4D illustrates an example coupler fixture;

FIG. 4E illustrates example coupler electronics for the coupler fixture of FIG. 4D;

FIGS. 5A and 5B show front and back side views of an example two-rack system configured with I-Button fixtures and couplers;

FIG. 6 shows an example equipment configuration visualization tool in the form of a Main Tools Graphical User Interface (GUI);

FIG. 7 shows an example Database View generated after the “View DB” button in the Main Tools GUI of FIG. 6 has been activated;

FIG. 8 shows an example Network View generated after the “View Net” button in the Main Tools GUI of FIG. 6 has been activated;

FIG. 9 shows an example Equipment Specifics view generated in response to an equipment selection made via an example Database View expanded to its equipment level;

FIG. 10 shows an example Equipment Specifications view generated in response to an equipment selection made via an example Database Rack Drawing;

FIG. 11 shows an example of multiple Database Rack Drawings generated in an example graphical representation of selected equipment racks;

FIG. 12 shows an example of a GUI configured to compare and display differences between equipment configuration and other equipment information stored in a database and information discovered about an actual network of equipment;

FIG. 13 shows an example I-Button Programmer GUI generated after the “I-Button” button in the Main Tools GUI of FIG. 6 has been activated;

FIG. 14 shows an example Visualization Tool Java Package showing the unique Java Class composition within the Visualization Tool and the high-level class interaction;

FIG. 15A shows an example Equip Class for the Visualization Tool Package of FIG. 14;

FIG. 15B shows an example Rack Class for the Visualization Tool Package of FIG. 14;

FIG. 16 shows an example ButtonDriver Class and Object Diagram for the Visualization Tool Package of FIG. 14;

FIG. 17 shows an example AccessRack Class and Object Diagram for the Visualization Tool Package of FIG. 14;

FIG. 18 shows an example Frame_Draw, MyCanvas Class and Object Diagram for the Visualization Tool Package of FIG. 14;

FIG. 19 shows an example FrameButtonProg Class and Object Diagram for the Visualization Tool Package of FIG. 14;

FIG. 20 shows an example SysView, FrameSysView Class and Object Diagram for the Visualization Tool Package of FIG. 14;

FIG. 21 shows an example visual tool system in a Visual Tool Standalone Configuration;

FIG. 22A shows an example visual tool system in an Expanded Capabilities Configuration;

FIG. 22B shows operations and software components for an Expanded Capabilities Configuration;

FIG. 23A shows I-Button Fixtures and a Multi-Function Module;

FIG. 23B shows the Multi-Function Module of FIG. 23A; and

FIG. 23C is Multi-Function Module Block Diagram showing the functions provided by the Multi-Function Module of FIG. 23A.

### DISCLOSURE OF INVENTION

Various embodiments of the present invention pertain to Tool Sets that facilitate equipment configuration maintenance and control functions by leveraging existing inventory and tracking databases and extending them to a hardware and software infrastructure that allows personnel to examine, in real time and graphically, the exact total physical system rack equipment content, rack layout, equipment description, and equipment unique identification specifics on-line. In various embodiments, the Tool Set automatically analyzes and reports detected differences between the database and the existing physical laboratory (or other facility) configuration identifying present, missing and/or newly found equipment. This information allows users to reconcile their inventory databases based upon actual sampling of equipment conditions in real time. The Visual Tool does not replace inventory databases but uses them as a reference and automatically reports differences between the database and what actually exists. In various embodiments, the Tool Set accommodates multiple different but shared equipment configurations and their respective internal processes. In various embodiments, a cross-divisional Visualization Tool Set using electronic tagging accommodates the different laboratory lab rack configurations and internal processes of different government divisions such that specific rack equipment can be shared cross-divisional.

In the example embodiment described below, a Visualization Tool Set facilitates on-line laboratory equipment tracking and configuration control for a government laboratory. It should be appreciated, however, that the principles described herein are not limited to government equipment configurations, laboratories, or divisions. Moreover, the principles described herein are applicable to equipment configurations in laboratories as well as in other facilities. Additionally, the Tool Sets described herein can utilize communications networks other than the Internet, as well as wireless networks.

Visualization Tool Set for Laboratory Equipment Configurations

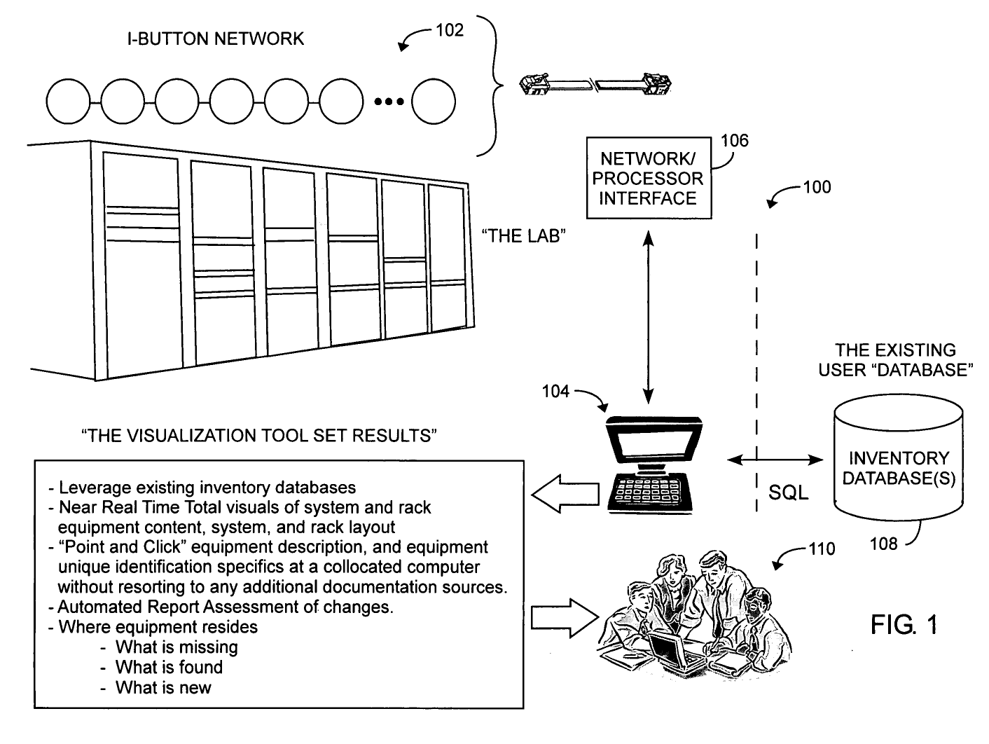

Referring to FIG. 1, in an example embodiment, an equipment configuration visualization system 100 includes an electronic tagging device network 102, a processor 104, a network/processor interface mechanism 106 and one or more databases 108, configured as shown. In this example embodiment, the processor 104 is programmed to provide users 110 of the equipment configuration visualization system 100 with a Visualization Tool Set that facilitates on-line equipment tracking and configuration control (e.g., for a government laboratory). By way of example, as illustrated in FIG. 1, “The Visualization Tool Set Results” include and/or enable a user to:
Leverage existing inventory databases
Near Real Time Total visuals of system and rack equipment content, system and rack layout
“Point and Click” equipment description, and equipment unique identification specifics at a collocated computer without resorting to any additional documentation sources
Automated Report Assessment of changes
   In this example embodiment, the electronic tagging device network 102 exploits a low cost COTS wired technology known as I-Button (IBUTTON® registered to Dallas Semiconductor Corporation). This technology was developed by Dallas Semiconductor/Maxim. The I-Buttons are inexpensive, small, rugged non-violate memory packages, about the size of a battery coin cell, that have intelligent one wire industry standard network interfaces built in. Each I-Button has a unique factory programmed 48 bit ID used to access the device over the network by a host. The I-Button is extremely low power for long retention of memory content with lifetime expectancy of 10-15 years. In this example embodiment, the I-Button is used as the basic tagging component for the Visualization Tool. It should be appreciated, however, that other electronic tagging devices can also be employed.

According to various embodiments, equipment specific information is stored in electronic tags that are tied physically (or otherwise attached) to the equipment and the equipment electronic tags are wired (or otherwise operatively interconnected) together. As such, by way of example, users and maintenance personnel are provided with local and immediate access to this set of data sources directly facilitating lab equipment tracking, control and utilization needs. Embodiments described herein are suitable for various forms of equipment configuration maintenance, auditing, and “rack and stack” equipment staging where timely visualization content of the current configuration is important for the operation. Embodiments described herein are upwards scalable to large systems (e.g., laboratory systems) and downwards scalable to standalone “Mini-rack” deployable lab fielded equipment configurations.

In this example embodiment, the network/processor interface mechanism 106 includes a DS9097 RS-232 to I-Button Adapter. Thus, in this example embodiment, the network/processor interface mechanism 106 functions as an active bridge coupler. This facilitates segmenting a chain of I-Buttons into isolated groups, e.g., per rack. Such an embodiment prevents failure of a single button from bringing down the entire system and also allows the software to effectively isolate the position of any button within any rack and to monitor when new equipment is added (e.g., inadvertently) to a rack. It should be appreciated that a different network/processor interface mechanism 106 can be used depending upon the particular components, arrangement, performance requirements, etc. of the equipment configuration visualization system 100.

In various embodiments, the Tool Set is a custom “plug-in” system application, using for example both custom “plug-in” application software and custom repackaged COTS hardware specifically targeted to the particular operational aspects of Laboratory rack and equipment management (e.g., within particular government divisions and/or other facilities with equipment configurations). In various embodiments, the Tool Set is based upon readily available and inexpensive COTS components but realizes a unique feature set through custom application code, and a low-cost custom hardware package. By way of example, technologies that can be used to implement the Tool Set are the Sun Microsystems JAVA programming language and the Dallas Semiconductor/Maxim I-Button hardware electronic tagging device. In an example embodiment, Sun Java SE or EE or ME Platforms can be used to write custom application code for the Tool Set. In various embodiments, a language (such as Java) that is portable across a variety of platform types ranging from desktop computers to laptops to handheld PDA's is used. The choice of such a language accommodates wider use and adaptation of the Tool Set without constraining the user to the type of computing device used.

With the incorporation and utilization of a custom Electronic Tagging scheme such as described herein, a user can access equipment specific rack locations, discern utilization and equipment composition documentation in a timely, straightforward matter. In various embodiments, the approach described herein eliminates the need for disparate access to multiple off-line databases for equipment specific information or for manual retrieval of basic rack configuration and layout data.

In this example embodiment, the Tool Set functions as an extension and overlay to existing inventory management systems. In the database 108, a unique ID is specified for each rack and equipment within the system. For installation, by way of example, the Tool Set supports retrieval of existing inventory data through SQL retrievals, and then the programming of individual I-Buttons with appropriate equipment and physical positional data through a custom GUI. Once the electronic tagging device network 102 (e.g., I-Button network) is wired and established the Tool Set performs real-time access to the data by polling the collective I-Button network “bound” to these racks and equipments. The existing inventory data and collected I-Button data are then compared and differences are automatically determined. In an example embodiment, a summary analysis is presented to the user. In an example embodiment, the user is also assisted graphically with a scrollable tree structure hierarchy view of all equipment and racks within the system (e.g., laboratory system). In an example embodiment, the user also is provided with an on-demand ability to view a graphic display of any or all rack drawings.

In an example embodiment, an equipment configuration visualization method includes securing electronic tagging devices to equipment, remotely networking the electronic tagging devices, polling the electronic tagging devices to retrieve equipment configuration information stored in the electronic tagging devices, and generating visual representations from the equipment configuration information.

System Operation

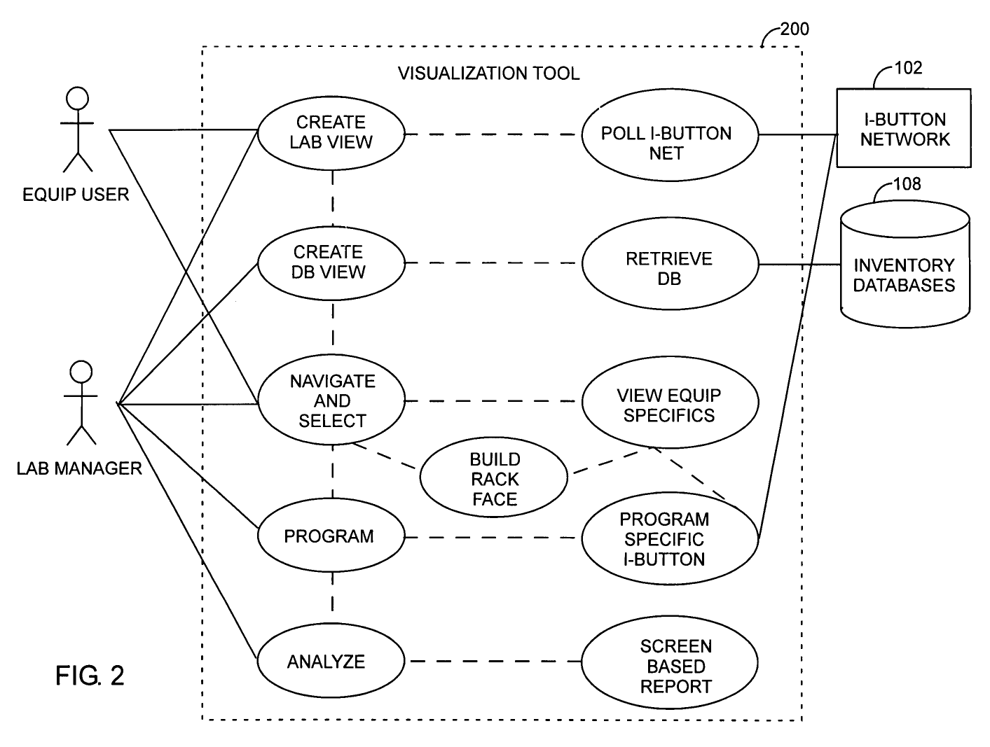

In an example embodiment, Unified Modeling Language (UML) is implemented to describe the user operation of a Visualization Tool Suite. FIG. 2 illustrates the Use Case for an example Visualization Tool 200. In an example embodiment, a Visualization Tool Suite supports distinct groups of users with different privileges. In this example, a user denoted “Equip User” is provided with access to tools that allow the user to create accurate, up-to-date Lab equipment views and then proceed to navigate the particular equipment network view to derive both rack face drawing graphics and/or equipment detailed specifications. Various components of the Visualization Tool Suite help the user to understand the available current equipment resources, where they are, and their capabilities (e.g., to facilitate the user's mission or job function). By way of example, the user can activate the I-Button network polling function on demand and then “point and click” to any rack and associated equipment to gather critical equipment information specifics.

In this example embodiment, the user denoted “Lab Manager” has access to all of the “Equip User” capabilities and more. In this example, functions of the “Lab Manager” are to understand total current configurations and facilitate their control. To facilitate these functions the Visualization Tool provides this user with access to the existing equipment sets as well as access (e.g., via password) to the inventory database to allow the user to determine what is missing, new, and/or removed. In this example embodiment, the Visualization Tool supports automated analysis and reporting functionality. With this capability this user can have the system automatically determine the difference between the “known truth”, or inventory database, and the actual existing system composition. This enables the Lab manager to track equipment more effectively. In this example embodiment, an additional capability supported by the Visualization Tool to this user is I-Button programming. This function enables this privileged user to program I-Buttons, a necessary prerequisite to the total Visual Tool system setup.

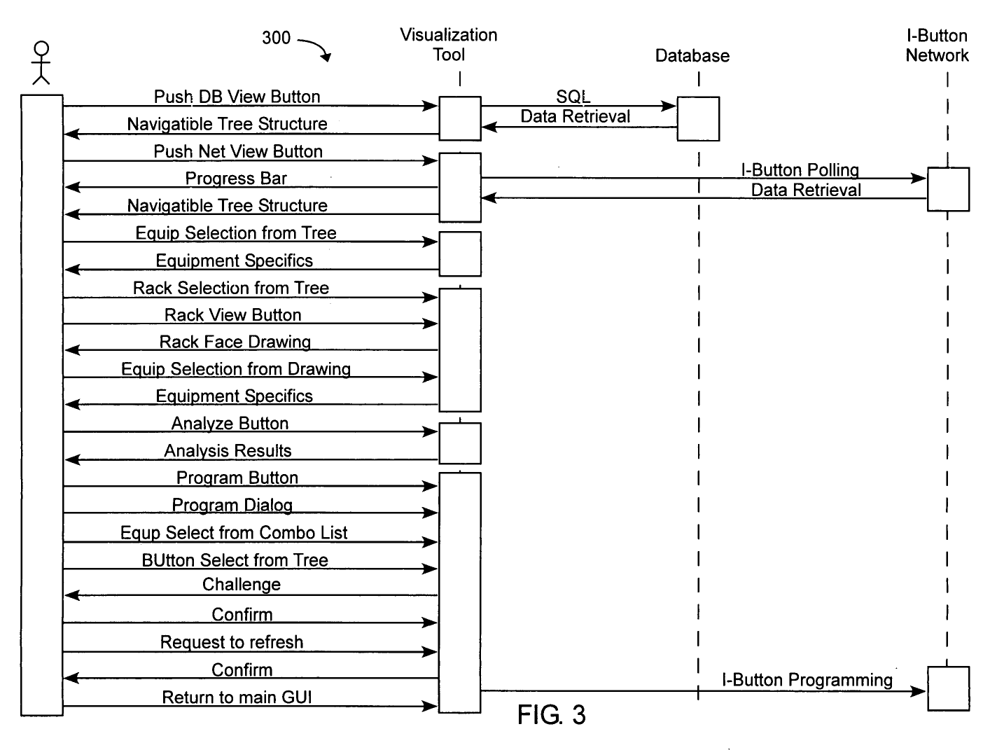

Referring to FIG. 3, in the paradigm of UML at this level of description an additional graphic is provided in the form of an example Visualization Tool UML Collaboration Diagram 300. In this time-sequenced diagram, interactions among the major objects (in this example embodiment, the User, the Visualization Tool, the I-Button Network, and the database) of an example system are displayed. An example User GUI is described below in the section entitled “Tool Set GUI Interface”.

I-Button Programming and I-Button Network Hardware

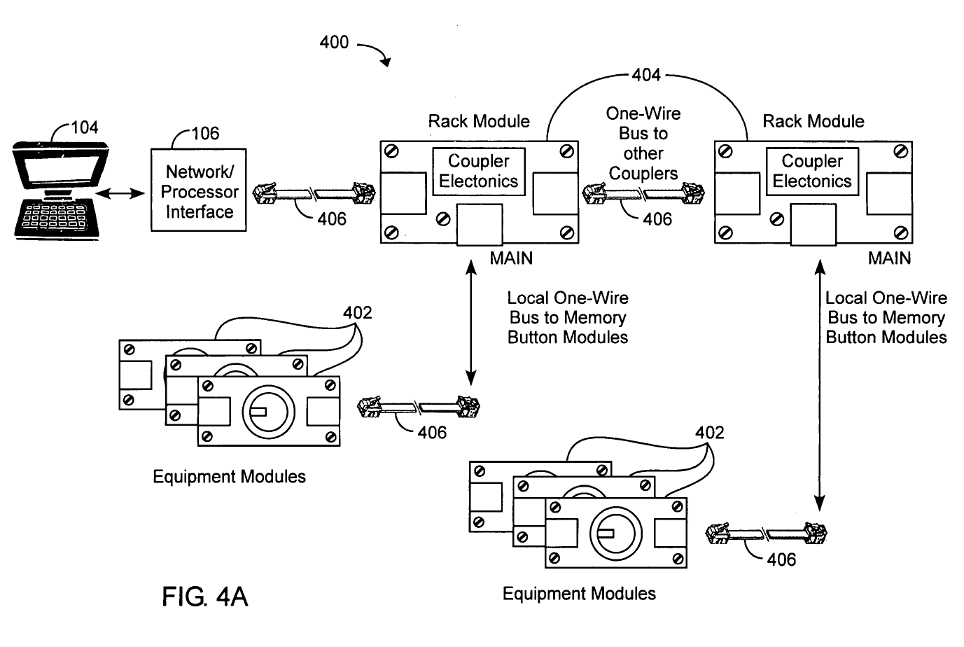

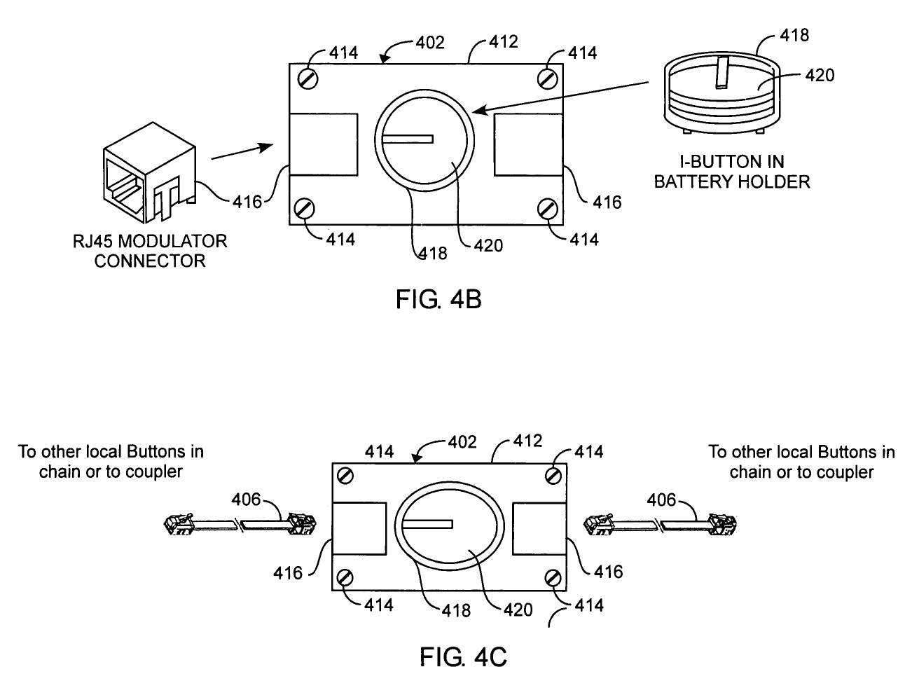

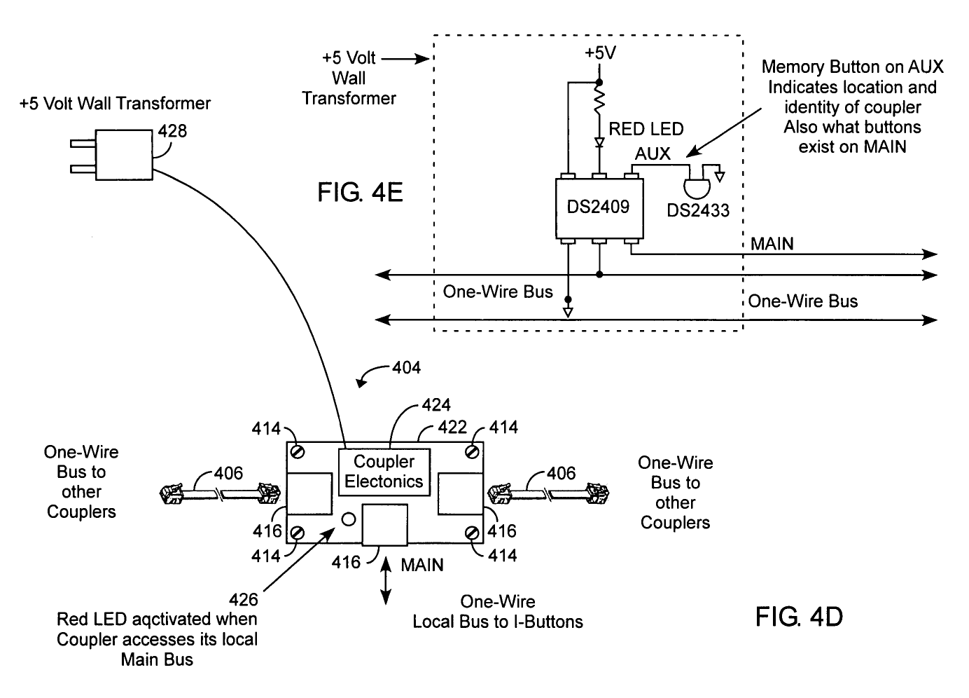

FIG. 4A illustrates components of an example I-Button network 400. A representative thread from host computer through couplers through I-Buttons is shown. In this example embodiment, the I-Button network 400 includes a number of I-Button fixtures 402 (“Equipment Modules”—one per equipment typically), a number of coupler fixtures 404 (“Rack Modules”—one per rack typically), and interconnecting cables 406 configured as shown. Referring to FIGS. 4B and 4C, in an example embodiment, the I-Button fixture 402 includes a housing 412 and screws 414 (or other securing mechanism) for mounting the I-Button fixture 402 to host equipment. The example I-Button fixture 402 also includes connectors 416 and an I-Button electrical interface 418 which are operatively interconnected within the housing 412. FIG. 4B illustrates the I-Button fixture 402, with the connectors 416 (in this example, RJ-45 modular connectors) and the I-Button electrical interface 418 (in this example, a battery holder) holding an I-Button 420 shown in perspective. Referring to FIG. 4D, in this example embodiment, the coupler fixture 404 includes a housing 422 and screws 414 (or other securing mechanism) for mounting the coupler fixture 404 to a selected object. The example bridge fixture 404 also includes connectors 416 (in this example, RJ-45 modular connectors) which are operatively interconnected within the housing 422 to provide a mechanism for electrically interconnecting multiple I-Button fixtures 402 via the interconnecting cables 406. It should be appreciated that the principles described herein are not limited to fixtures with two or three connectors, to modular connectors, or to connectors of any particular type. Moreover, the fixtures described herein are not limited to I-Button electrical interfaces in the form of battery holders. In this example embodiment, the coupler fixture 404 also includes coupler electronics 424, an activity LED 426 (e.g., activated when the Coupler accesses its local Main Bus), and +5 volt DC wall transformer 428 for power. Referring to FIG. 4E, in an example embodiment, the coupler electronics 424 include a DS2409 MicroLAN Coupler, a DS2433 4 kb 1-Wire EEPROM, and a red LED configured as shown. The 1-Wire (1-WIRE® registered to Dallas Semiconductor Corporation) technology is made by Maxim/Dallas Semiconductor and offers the same electrical interface and functionality as the I-Button but in a smaller package. In this example, the DS2433 4 kb 1-Wire EEPROM (or “Memory Button”) is connected to the AUX input of the DS2409 MicroLAN Coupler to indicate the location and identity of the coupler, and to indicate what buttons exist on the MAIN input of the DS2409 MicroLAN Coupler.

In an example embodiment, a 4 kb I-Button is attached per equipment. All I-Buttons are then connected together through the couplers in a continuous dual wire net (one wire represents data, the other electrical return). The net is wired to transverse all equipment within the system and then terminates at the Visualization Tool System Computer. This termination is through an I-Button net to RS-232 Interface (Maxim Dallas Semiconductor Part DS-90097). The maximum speed of this net is 115 Kbps, so for large systems the total polling sequence may be in the order of several minutes. The advantage of this net configuration is that the polling software resident in the Tool Set will know if equipment is present or absent within the system based upon an I-Button response. With this capability, if the rack or equipment is added or removed, the Tool Set software will be aware of this. The Tool Set facilitates an I-Buttons programming system though the use of its I-Button Utility custom software. The software allows the user to automatically format equipment specific data to program I-Button memory and coupler memory from queries against an existing inventory database. In an example embodiment, the data requirements for this tool on inventory data are that each rack and equipment be uniquely identified and that the equipment rack height and rack position are also specified. In an example embodiment, the I-Button data incorporates a data efficient representation of the key inventory metadata fields using commas as delimiters and “˜” as EOF. See Table 1 below.

TABLE 1
Database Metadata vs. I-Button Packed ASCII Format and Coupler Format

| Metadata from | Packed ASCII I-Button | Representative ASCII |
|---|---|---|
| Database Query | Format | Coupler Format |
| Rack 74 | RK74, A1, 3U, KC0014, | RK74, size of Rack, |
| Site ID = KC0014 | null, 87511A, 3026J00591, | System, List of all |
| Manufacturer Model | S-Paramter Test˜ | Equipment IDs |
| Number 87511A | | within Rack˜ |
| Description | | |
| S-Parameter | | |
| Test Set | | |
| Agency ID #null | | |
| RACK Position 1 | | |
| Equip Serial # | | |
| 3026J00591 | | |
| Rack Size 3 | | |

To support ease of installation and removal of equipment, the network can be provided with common hardware cables and fixtures. In an example embodiment, the network utilizes either CAT-5 specification network cable or telephone cable for interconnection. The largest difference between uses of these cable types is that full 300-meter runs can be achieved with CAT-5 while telephone cable is suitable for runs only under 30 meters. For purposes of describing this example embodiment, CAT-5 specification cable will be discussed. In the example embodiment shown in FIG. 4A, Individual Equipment network accessibility is through the use of modular RJ-45 at both ends of the I-Button fixture 402 and RJ-45 at the coupler fixture 404. The coupler fixture 404 allows the network to connect in a daisy chain fashion from one coupler to another. Branching off of each coupler is a local two wire bus to support a daisy chain of local equipment based I-Buttons.

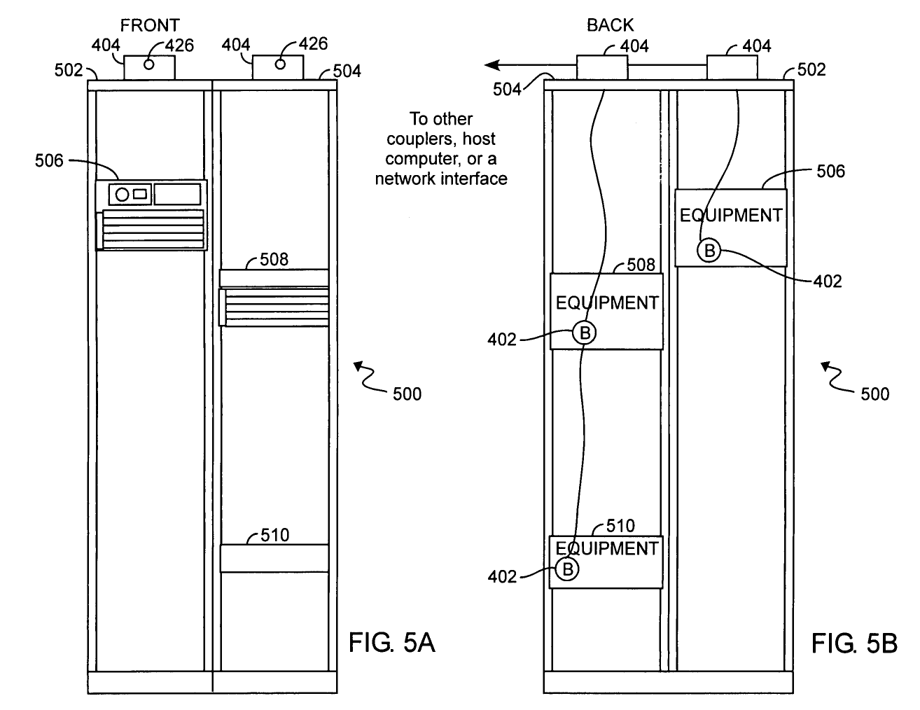

FIGS. 5A and 5B show front and backside views of an example two-rack system 500 configured with I-Button fixtures. In this example embodiment, the example two-rack system 500 includes racks 502 and 504 and equipment 506, 508 and 510 arranged as shown. In this example system, each equipment is provided (e.g., contains) its own I-Button fixture 402. The fixtures are part of the Visual Tool custom hardware and, by way of example, can take the form of a printed circuit card that is mounted to the equipment. In an example embodiment, the fixture supports an I-Button that is plugged into a coin cell battery holder (for ease of removal and programming) and two RJ-45 connectors for network connection and continuity. Alternately, one or more of the fixtures can be replaced with a Multi-Function Module (discussed below).

To help in cable layout across the racks 502 and 504 and provide local isolation of individual I-Button chains, a second fixture (e.g., a coupler fixture 404) can be used. As discussed above, the coupler fixture 404 has active components on it and functions as a network bridge with three RJ-45 connectors. The couplers provide a mechanism for interfacing with other couplers, a host computer, or a network interface. In this example embodiment, the coupler fixtures 404 are positioned atop the racks 502 and 504 such that their LEDs 426 (FIG. 5A) are visible from the front side of the racks when activated. This example hardware configuration scheme allows installation to proceed as follows: program the button, mount fixture on equipment, mount equipment to rack, connect I-Button fixtures (e.g., with CAT-5) in the rack, program the coupler memory, mount coupler fixture to rack, and connect the buttons across racks using the couplers. By way of example, the information for each piece of equipment within its I-Button is an equipment description, its rack, position within the rack and size, manufacturer model number, serial number, description, specific lab equipment identification number, and any cross agency reference number. By way of example, the information for each coupler on a rack is the system the rack is associated with, the rack size, a unique identification ID for the rack within the system, and a list of all equipment ID within the rack. It should be appreciated however that other information as well as other combinations of information types can be stored within the I-Buttons and/or other electronic tagging devices employed.

In an example embodiment, an equipment configuration visualization apparatus includes a fixture including an interface for an electronic tagging device, connectors for operatively interconnecting the fixture with external devices, and an electrical interface between the interface and the connectors.

Tool Set GUI Interface

In various embodiments, equipment configuration visualization tools permit a user to access a target system (e.g., a Lab system) connected to a network of electronic tagging devices (e.g., an I-Button network) through a Graphical User Interface (GUI). By way of example, GUIs described herein can be written using Java SE 1.4 and with SWING classes.

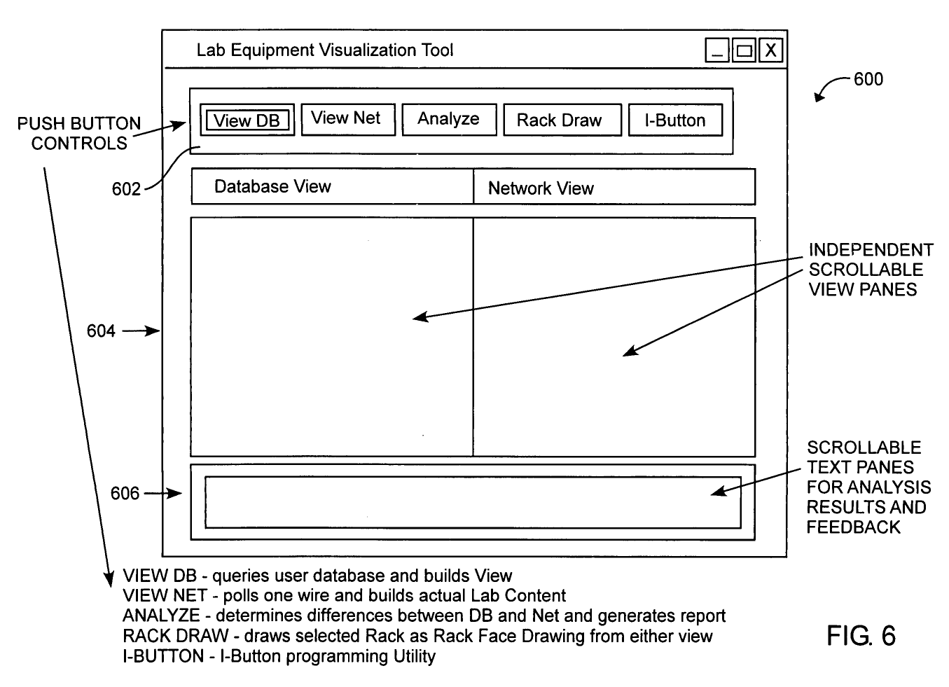

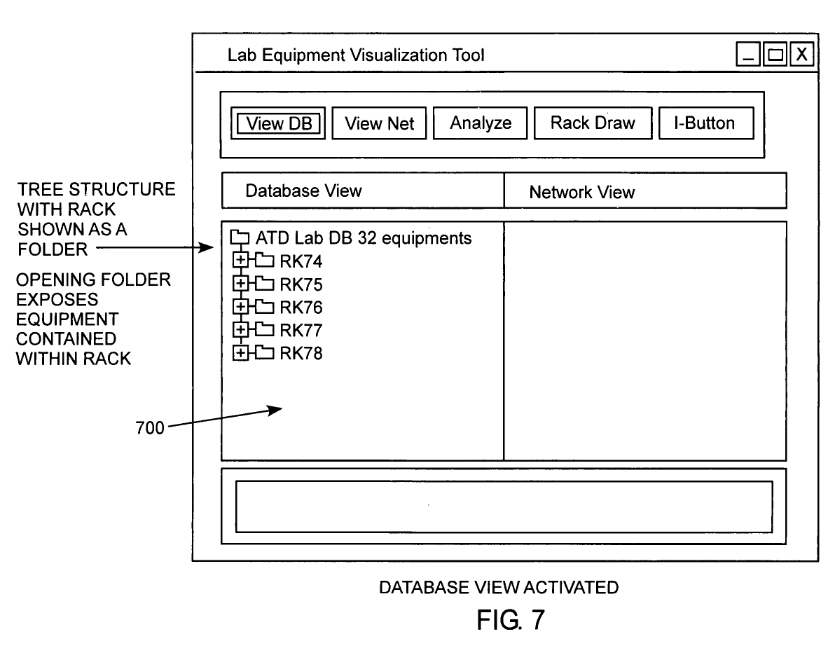

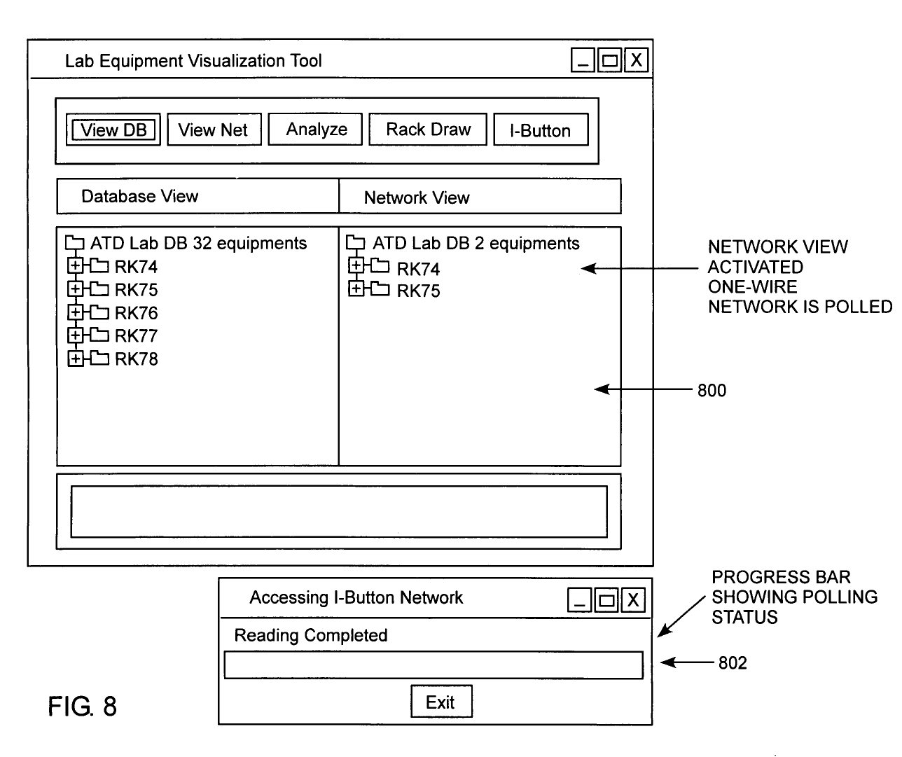

Referring to FIG. 6, in an example embodiment, a main start up GUI 600 is sectioned into a top panel 602, a middle panel 604 and a bottom panel 606 as shown. In this example embodiment, the top panel 602 facilitates user control via five graphical “push buttons” which are selectable, for example, with a “Point and Click” user input mechanism such as a mouse. In this example embodiment, the push buttons are denoted “View DB”, “View Net”, “Analyze”, “Rack Draw” and “I-Button”, and perform the following functions:
View DB—activates queries (e.g., SQL queries) to the database (e.g., a User supplied Database). Based upon those query results, and referring to FIG. 7, in an example embodiment, the Tool Set builds from the stored database a Database View 700 of the target system (e.g., a laboratory system) with the racks and equipment being depicted in a tree structure. It should be appreciated however that the Database View can include graphical representations that differ in content and/or structure from the afore-described hierarchical tree structure.
View Net—activates the polling sequence to the attached target network (e.g., lab target one-wire network). By way of example, FIG. 8 shows an example Network View 800 generated after the “View Net” button has been activated. In this example embodiment, while the polling is occurring, a progress bar 802 is displayed to indicate polling progress. Based upon these results, the Tool Set builds the existing Network view of the target system (e.g., a laboratory system). In this example embodiment, the racks and equipment are depicted in a tree structure; however, graphical representations that differ in content and/or structure can also be employed.
Analyze—causes the Tool Set to compare the Database results against the actual retrieved (polled) results. By way of example, the analysis results include the number of equipment found, what is missing, and what has been added.
Rack Draw—displays a Rack Drawing (e.g., in response to selection by the user of a Rack Icon) that is presented in either the Database View or the Network View. In an example embodiment, the user can cause to be displayed any number of Rack Drawings (to the full extent of the entire target system).
I-Button—activates a Tool Set I-Button programming utility, which allows the user to select any particular equipment from the database and program an electronic tagging device (e.g., an I-Button) or coupler accordingly.

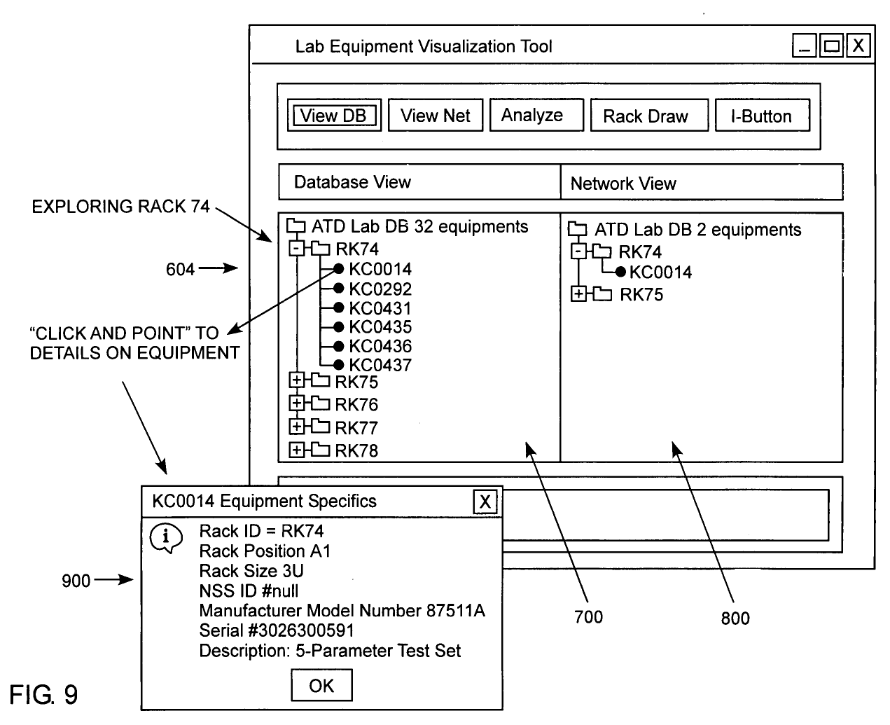

In an example embodiment, the middle panel 604 is divided into two independent scrollable displays, one to support the Database View 700 and the other to support the existing Network View 800. By way of example, and referring to FIG. 9, the Database View 700 and the Network View 800 are presented as left and right portions, respectively, of the middle panel 604. From these views the user can navigate to the rack of interest and then to the equipment of interest. Once at the equipment level, in an example embodiment, a user input can be input (e.g., via a “point and click” on an equipment icon) resulting in an information message Dialog 900 containing the equipment specifics to be displayed. In this example embodiment, the displayed Equipment Specifics include “Rack ID”, “Rack Position”, “Rack Size”, “ID#”, “Manufacturer Model Number”, “Serial #”, and “Description”. It should be understood however that different equipment specifics, as well as different arrangements of equipment specifics, can be displayed.

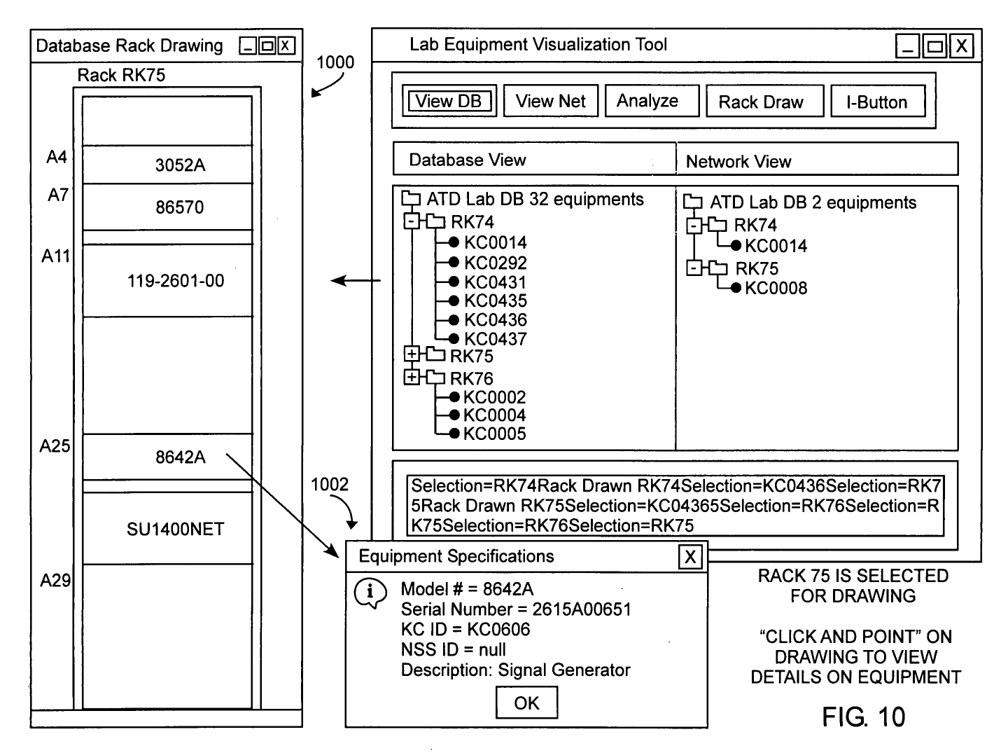

According to various embodiments, equipment configurations are graphically displayed as drawings or images of the racks and equipment therein. Referring to FIG. 10, in an example embodiment, a GUI is configured to facilitate selection of database information at the rack level (e.g., by “pointing and clicking” on a screen icon and/or text) and subsequent automatic generation of a Database Rack Drawing 1000 from the selected database information. In this example, Rack 75 is selected and the resulting Database Rack Drawing 1000 provides a graphical representation of Rack 75 as well as the equipment positioned therein.

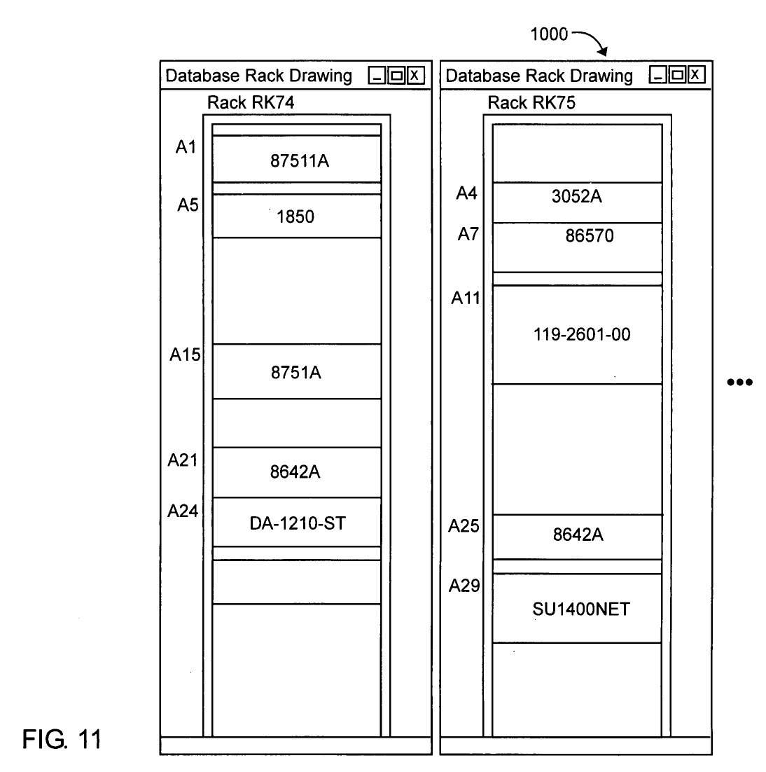

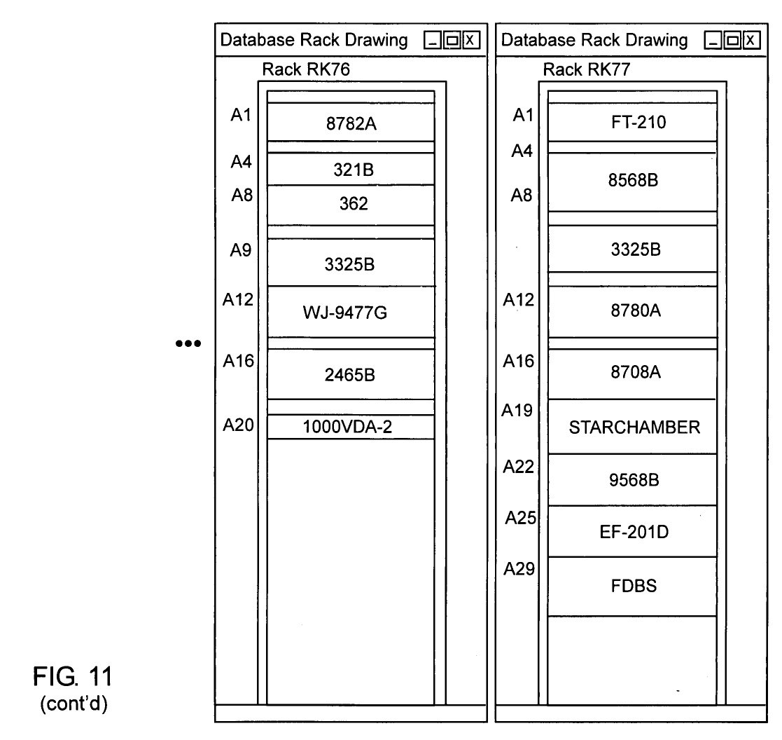

In this example embodiment, the Database Rack Drawing 1000 provides a mechanism for accessing equipment specifications. In this example embodiment, the GUI is configured to permit a user to point and click directly on the graphical representation of a particular piece of equipment depicted in the Database Rack Drawing 1000 to provide the user with access to equipment specifications for the selected equipment. In this example, Equipment Specifications 1002 is generated from database information when the piece of equipment denoted “8642A” is selected. In this example embodiment, the user is provided with alternate mechanisms for accessing equipment specifics, i.e., rather than selecting a piece of equipment from the Database Rack Drawing 1000, the user can expand the RK75 folder in the Database View in order to select at the equipment level. In an example embodiment illustrated in FIG. 11, a GUI is configured to permit a user to display multiple Database Rack Drawings. In this example, an entire rack face, which includes Racks RK74-RK77 is graphically presented in the form of composites for these selected components of the target equipment configuration.

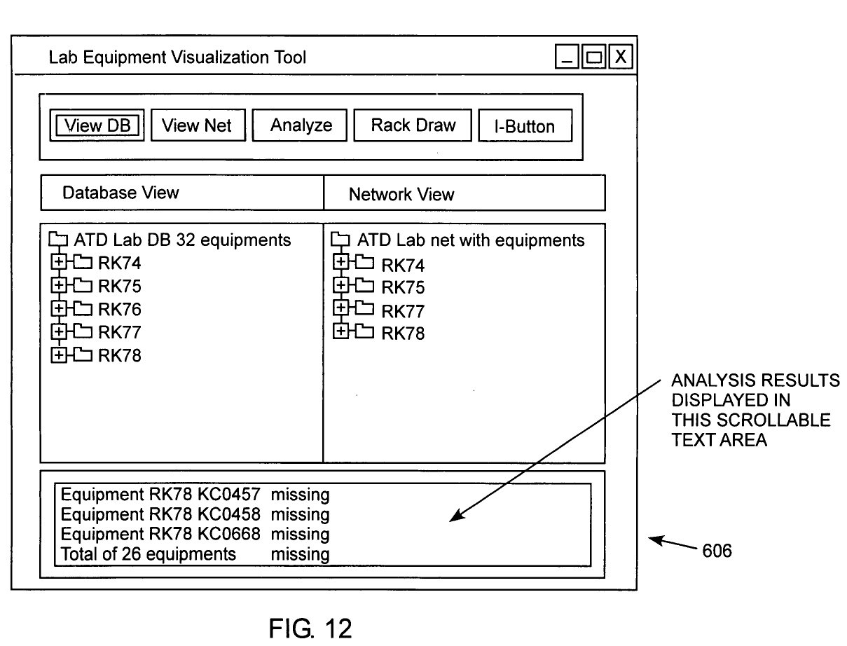

According to various embodiments, users are provided with tools for comparing and displaying differences between equipment configuration and other equipment information stored in a database and information discovered about an actual network of equipment. In an example embodiment, a GUI is configured to provide a user with a mechanism for making such a comparison and for viewing a graphical or other representation of the results of the comparison. Referring to FIG. 12, in an example embodiment, the bottom panel 606 of an example Tool Set GUI provides a scrollable text area for Tool Set analysis results and user feedback. In an example embodiment, the GUI is configured such that selection of the Analyze button effects a comparison between an Inventory-derived equipment list and a network derived equipment list. In an example embodiment, such a comparison checks the presence of each stored inventory item within captured data from polled network activity. By way of example, missing items are noted and logged, and items found outside what is present in inventory are marked as undefined. In the illustrated example embodiment, the analysis results are displayed in a scrollable text area below the Database View and Network View panes.

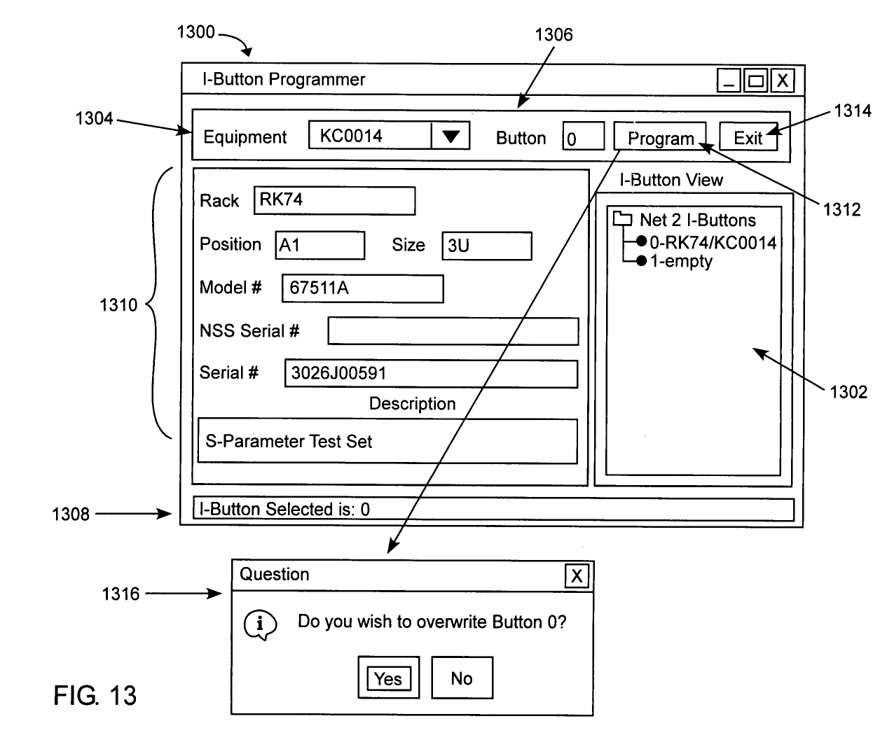

According to various embodiments, authorized users are provided with tools for programming electronic tagging devices such as I-Buttons. FIG. 13 shows an example I-Button Programmer GUI 1300 generated, for example, after the “I-Button” button in the GUI of FIG. 6 has been activated. In an example embodiment, the Tool Set will not enter this I-Button Utility unless a Database View has already been created, because it draws from this view for its programming data. If a Network View has not been established before entering the utility, then in an example embodiment the I-Button Utility automatically polls and presents the network, not as Rack folders, but as individual I-Buttons that are present on the network whether programmed or not. In this example embodiment, the I-Button Programmer GUI 1300 includes an I-Button View window 1302 which provides a graphical representation (e.g., as a hierarchical tree structure) of buttons on the network, an Equipment Selection Combo Box 1304, a Button window 1306, and a Status Bar 1308. In an example embodiment, each I-Button has a unique numerical designator, which is shown in the Button window 1306. In this example embodiment, the user selects the equipment programming details from the Equipment Selection Combo Box 1304 and then selects the I-Button to receive that programming by “clicking and pointing” on the appropriate element in the provided tree structure shown in the I-Button View window 1302. In this example, the Status Bar 1308 then provides an indication of which I-Button has been selected. In this example embodiment, Text Fields 1310 display retrieved Database content (i.e., the selected equipment programming details). In this example embodiment, the I-Button Programmer GUI 1300 also includes a Program button 1312 and an Exit button 1314. In this example embodiment, the user activates the Program button 1312 to initiate an I-Button Programming Command. If a button is already programmed, in this example embodiment, the utility will verify with the user through an option dialog window 1316 whether the user wishes to continue with an overwrite operation. In this example embodiment, the user activates the Exit button 1314 to exit from the I-Button Utility.

In an example embodiment, an equipment configuration visualization apparatus includes a visualization tool configured to integrate a network of electronic tagging devices that are directly and/or remotely interfaced with the visualization tool. The electronic tagging devices store information associated with equipment. The visualization tool is configured to poll the electronic tagging devices to obtain the information and to generate visual representations from the information.

In an example embodiment, an equipment configuration visualization system includes an interactive user interface that is networked to multiple storage devices secured to equipment, the interactive user interface being configured to allow a user to retrieve information from the storage devices and to automatically generate visual representations from the information.

Software Description

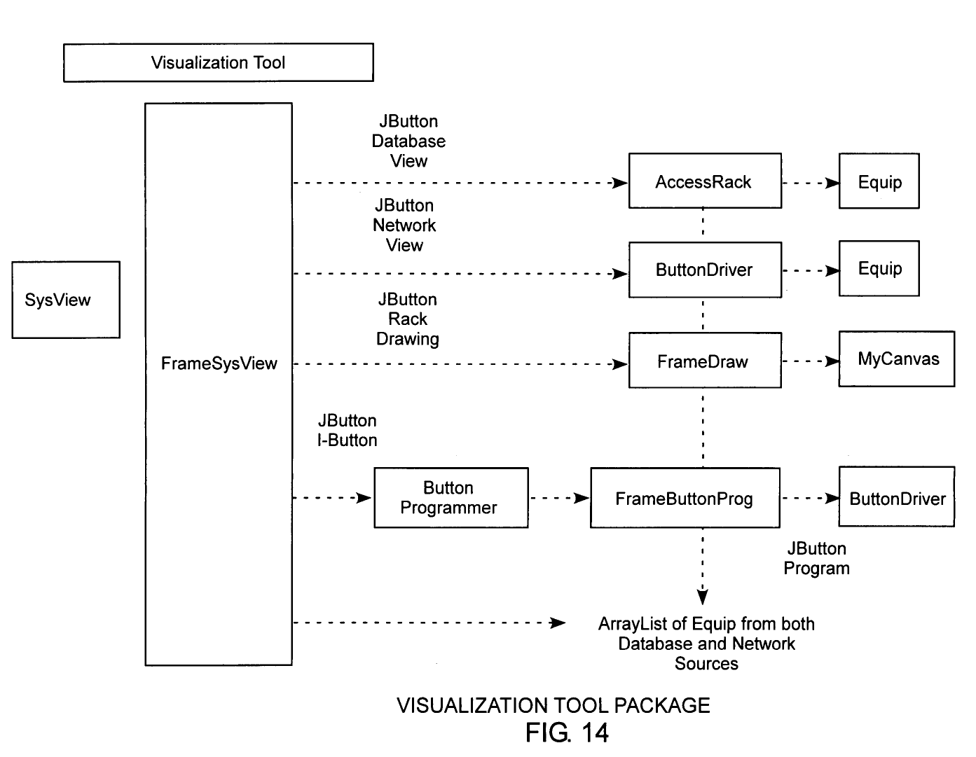

Referring to FIG. 14, in an example embodiment, equipment configuration visualization software can be implemented in the form of a total Java Software package. In this embodiment, the software is scalable to any system size. In this example embodiment, the Visualization Toll Package includes the following unique Java Class Components:
SysView.java
   Main Function
   Creates a Frame and Screen Position for Principal Operator GUI
FrameSysView.java
   Principal Operator GUI
   Operator Interaction with this GUI via Button selection invokes major Visual Tool actions
AccessRack.java
   Develops database connections and SQL query via URL and Query constructs
   Can be local or remotely activated
ButtonDriver.java
   I-Button Interface
   Facilitates discovery, read, and write to I-Buttons
Equip.java
   Visualization Tool Primitive representing equipment specifics
   Most cross class interactions deal with an Array List of this type
FrameDraw.java
   Creates a frame and screen position for the Rack Face Drawing
MyCanvas.java
   Rack Face Drawing primitive.
   Supports an automatic redraw of rack when resized or repositioned within screen.
ButtonProgrammer.java
   Creates a frame and screen position for I-Button utility
FrameButtonProg.java
   Operator I-Button Utility GUI
   Operator Interaction with this GUI invokes major I-Button programming actions (Install and build function for Lab Manager)

In the example illustrated in FIG. 14, the package diagram shows unique Java Class composition within the Visualization Tool and the high-level class interaction. In this diagram, all of the unique classes are shown, but not their particular instances. The actual instances are depicted below. Individual objects, attributes, and methods descriptions associated with the classes are also described in the following sections.

Java Class Descriptions

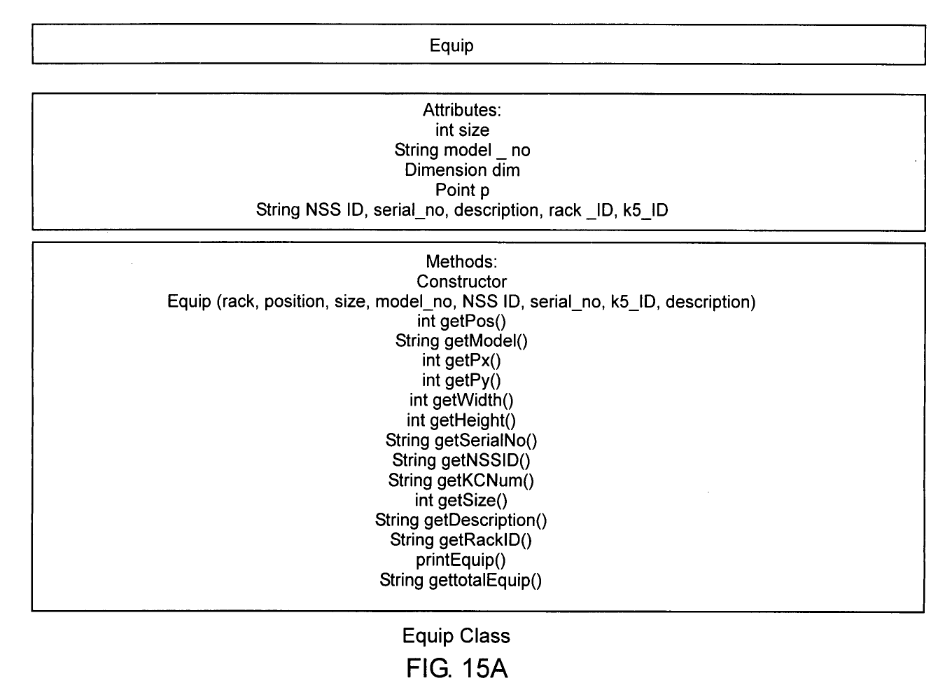

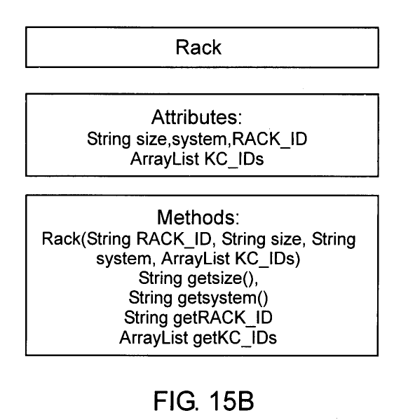

Equip.java—in the example embodiment shown in FIG. 15A, this class contains constructor, accessor, mutator methods and attributes to support the basic Equipment primitive. By way of example, attributes for this primitive include:

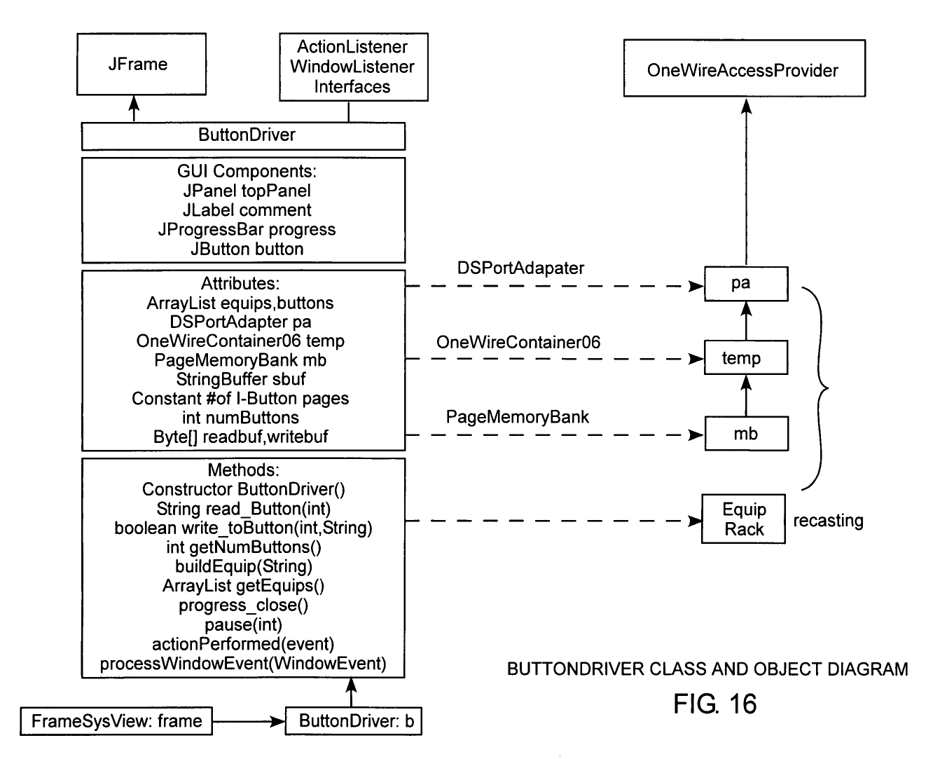

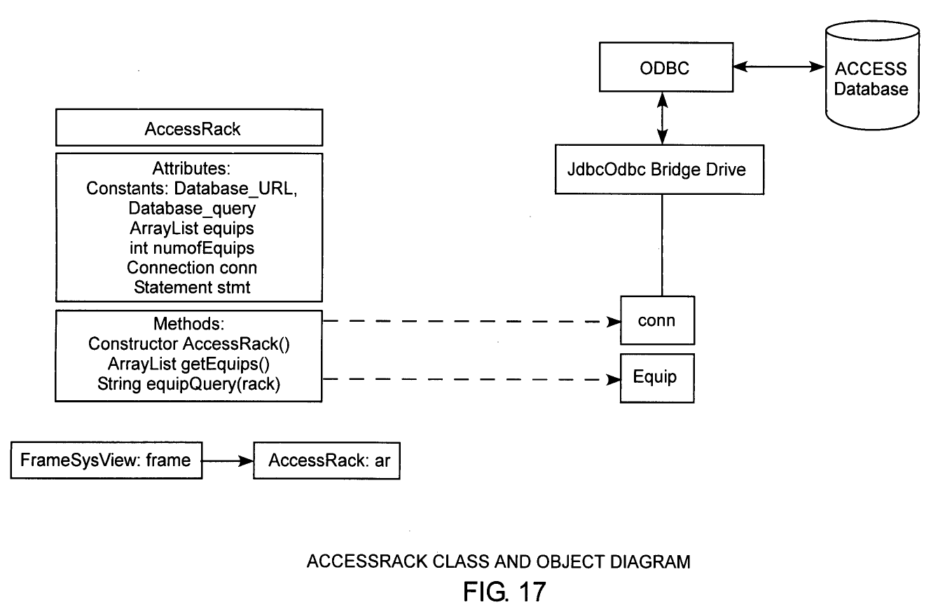

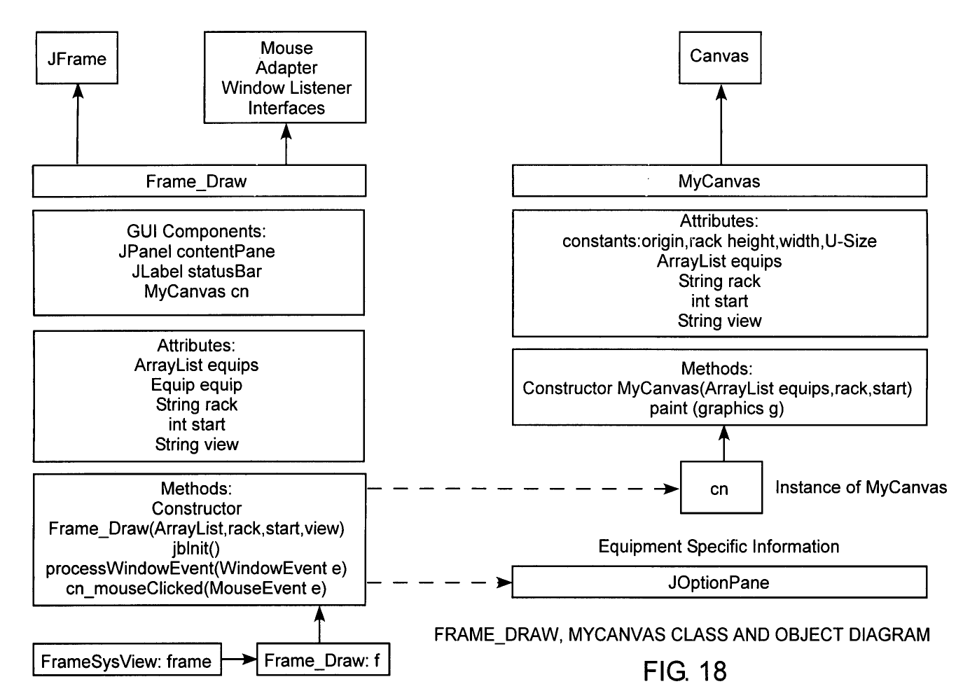

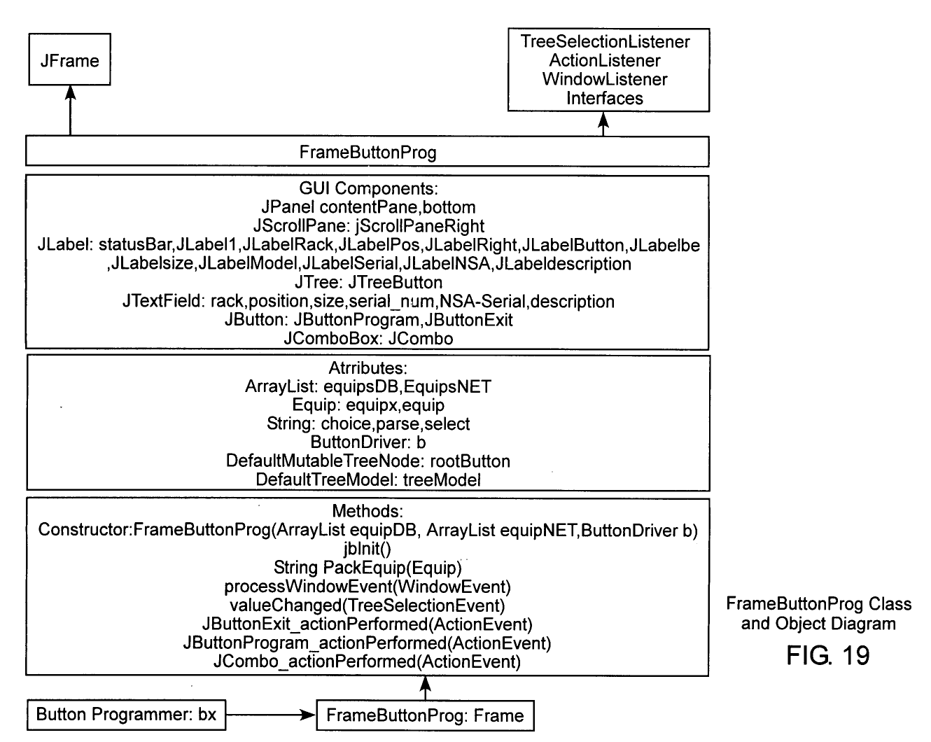

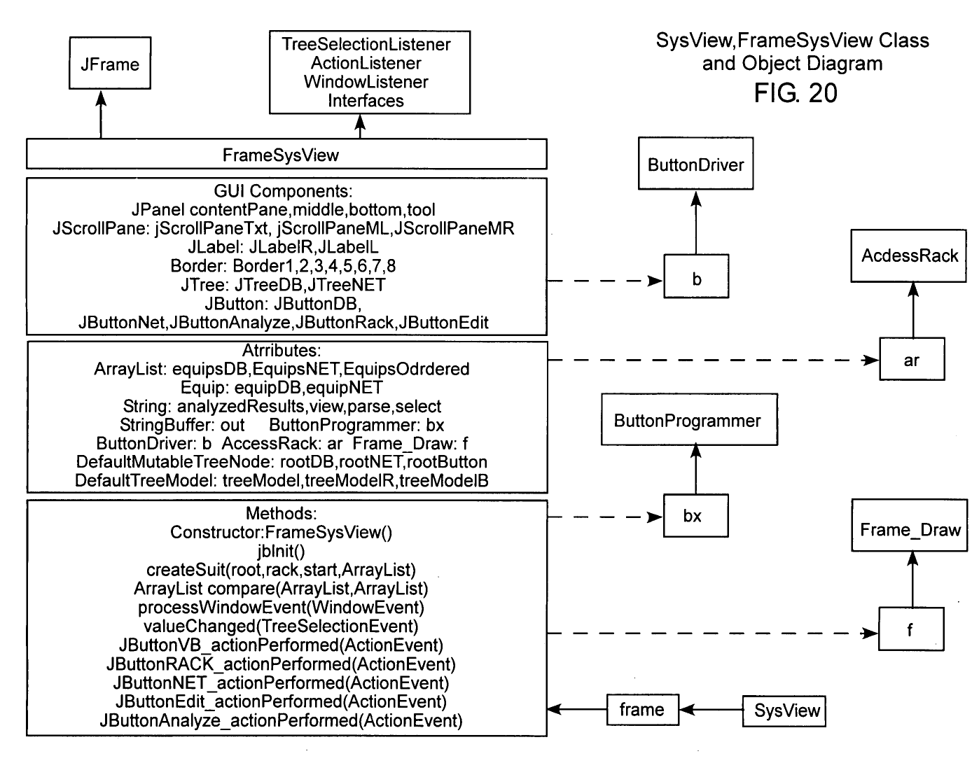

Size
Position within rack
Manufacturer Model Number
Manufacture Serial Number
Description
Agency Equipment ID Number
Divisional Equipment ID Number
Description
   Rack.java—in the example embodiment shown in FIG. 15B, this class contains constructor, accessor, mutator methods and attributes to support the basic Rack primitive. By way of example, attributes for this primitive include:
Size of Rack
Name of System Rack is associated with
Unique Rack Identifier within the system
ArrayList of all unique equipment Identifiers that should be in the Rack
   ButtonDriver.java—in the example embodiment shown in FIG. 16, this class functions as the low-level I/O driver for the Visualization Tool during I-Button initialization, addressing and data exchange. In an example embodiment, it utilizes classes from the TMEX Software 1-Wire JAVA API (designated OneWireAccessProvider) to facilitate creating the I-Button Master, searching for all button types on the I-Button network and then expediting all communication for the user in programming and reading data to/from the I-Button. In an example embodiment, the ButtonDriver instance is created from FrameSysView.java (the main GUI program). The ButtonDriver instance, in turn, creates an instance of a master port adapter for the 1-Wire Master using the DSPortAdapter class. In an example embodiment, the getDefaultAdapter method for the DSPortAdapter class is used and, as a result, the COM1 port of the laptop is utilized. In this example, any serial port can be used as long as it meets a throughput rate of 115 Kbps. To meet the electrical interface requirements for the I-Button, a MAXIM Dallas Semiconductor DS9097 RS-232 adapter to I-Button adapter can be used. This adapter physically connects to the laptop serial port as an extended 9-pin DIN back shell and contains necessary electrical drivers with the RJ-45 interface on one side. Once the port is established, in an example embodiment, this class performs an automatic directed search for all 4 kb I-Buttons on the attached I-Button Network. For each 4 kb Button found, this class creates an instance of an API class specific to 4 Kb button (OneWireContainer06), to access specific methods offered by the API for 4 Kb button. With an instance of OneWireContainer06 created for each Button, the PagedMemoryBank interface (via recast) is made available. It is through this interface that the actual reading and writing to the I-Button memory pages is performed. In an example embodiment, all I-Button memory exists as paged memory, where each page size is a fixed 256 kb long. For the 4 KB button, the total number of pages offered is 16. PagedMemoryBank supports reading and writing to pages over the I-Button network using a Universal Data packet format with CRC. The ButtonDriver handles all class exceptions including I-Button communication errors and reports exceptions back to the calling programs. In an example embodiment, the ButtonDriver.java reports its polling progress to the user via a progress bar GUI. In an example embodiment, the ButtonDriver.java exits if no button is found and alerts the calling programming of that condition with a “no I-Buttons Found” message. A similar scheme is used to access the coupler memory. In this case the only difference is that an Instance of OneWireContainer1F is used.
   AccessRack.java—in the example embodiment shown in FIG. 17, this class uses the Java Database Connectivity (JDBC) class within the Java SE API to connect to a Microsoft Access Database, query the database and pass the query results onto the invoking process. In an example embodiment, the class uses a database URL that represents a user's inventory database. This URL can represent a local or remote database connection. In an example embodiment, the pre-configured database contains two tables, one for Racks and the other for Equipment. In an example embodiment, fixed SQL queries are developed for each of the tables to support the necessary information pulls for I-Button initializations. These SQL queries can be changed to support pulls from other types of databases (and associated schemas) that may be used with this system. In an example embodiment, AccessRack.java handles data base connection error exception and SQL error exceptions within the class. In an example embodiment, the constructor determines all the individual racks within the database. In an example embodiment, there is one public method, to query Equipment Table for all equipment within a rack.
   FrameDraw.java—in the example embodiment shown in FIG. 18, this class extents Java Swing Class JFrame and invokes MyCanvas.java to built a composite frame with the canvas, and a status bar for display to the user. In an example embodiment, in addition Frame Draw provides a mouse event handler that allows a user to view detailed information on a particular piece of equipment through a displayed JOptionPane.showMessageDialog by simply clicking on the equipment within the drawing. In an example embodiment, all available information on that equipment is displayed in the message dialog box.
   MyCanvas.java—referring also to FIG. 18, this class extents the Java AWT Canvas Component and is used to provide the user with essentially a rack face drawing on the computer screen (i.e. a two-dimensional graphic drawing of the rack and its contents). In an example embodiment, its constructor requires two arguments: array of equipment and rack designation. By way of example, the rack default is 80″ and the scale is about 1:14 with a 1024 by 768-resolution display setting using a 0.125″ per pixel template. In an example embodiment, MyCanvas.java overrides the default paint method associated with AWT components so that the rack face drawing is automatically redrawn when the canvas recovers from resizing or hidden conditions on the computer desktop.
   FrameButtonProg.java—in the example embodiment shown in FIG. 19, this class extents Java Swing Class JFrame and appropriate interfaces to provide an I-Button Programming Utility. In an example embodiment of this utility, the user selects a equip type from the existing database equipment list and a button from the existing button array and then selects a reprogramming or programming exercise.
   FrameSysView.java—in the example embodiment shown in FIG. 20, this class extents Java Swing Class JFrame and appropriate interfaces to provide a GUI main menu. In an example embodiment, major features are the tree structures for component selection and button activation. In an example embodiment, FrameSysView.java creates instances of all the other classes as a result of ActionListener functions associated with the GUI buttons.
   Visual Tool System Remote Operation and Expansion

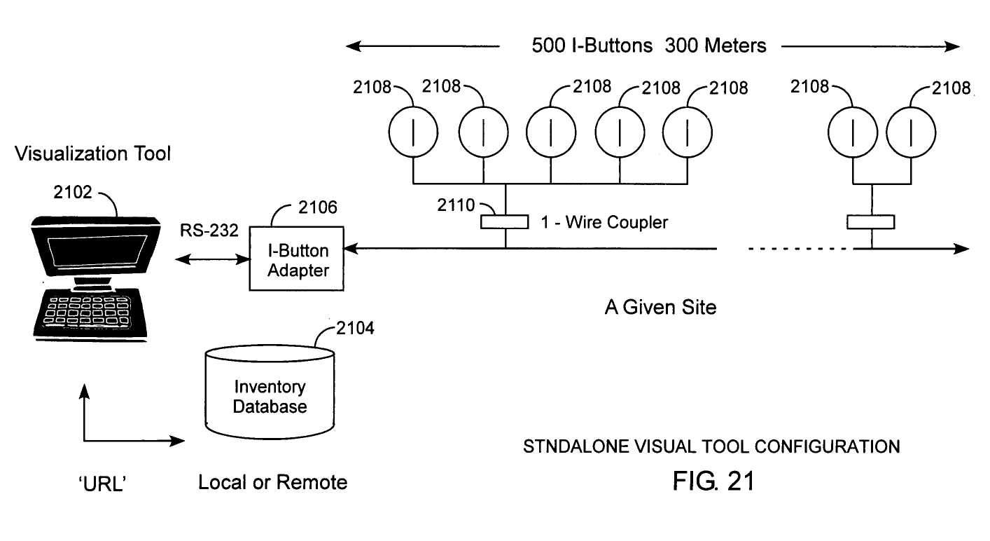

In an example embodiment shown in FIG. 21, a visual tool system 2100 includes a Visualization Tool 2102, an inventory database 2104, an I-Button Adapter 2106, I-Buttons 2108, and a 1-Wire Coupler 2110 configured as shown. In this example embodiment, the inventory database 2104 can be local or remote. This Standalone Visual Tool Configuration is suitable for a single laboratory or other operating environment, where a 300-meter, 500 I-Button limitation poses no constraints.

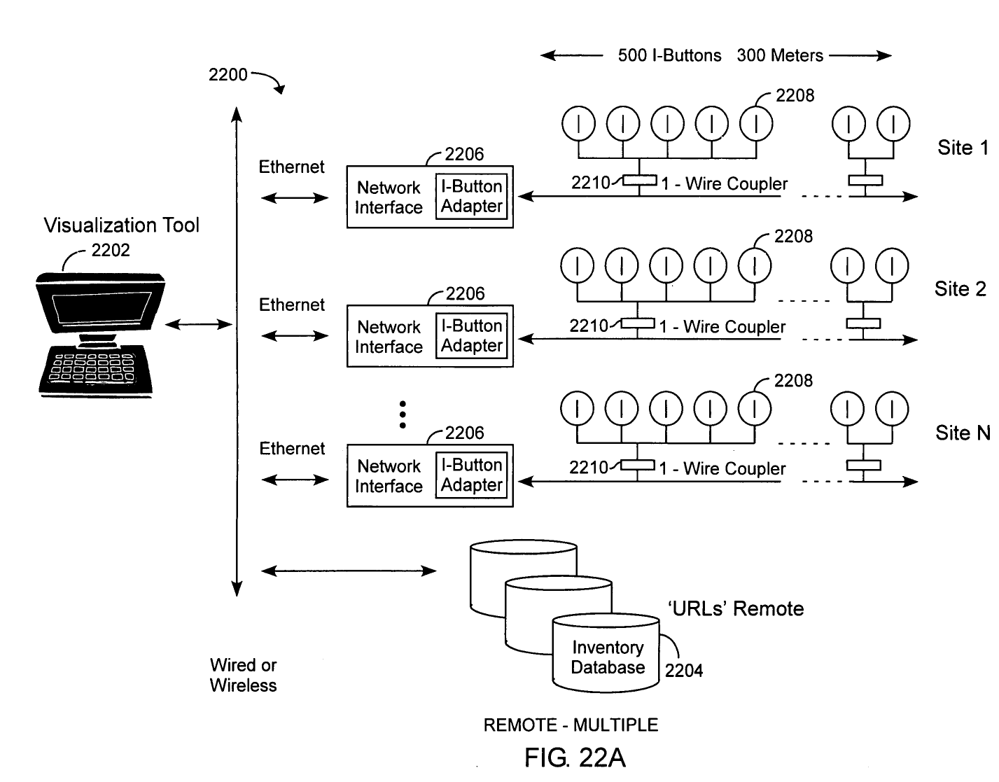

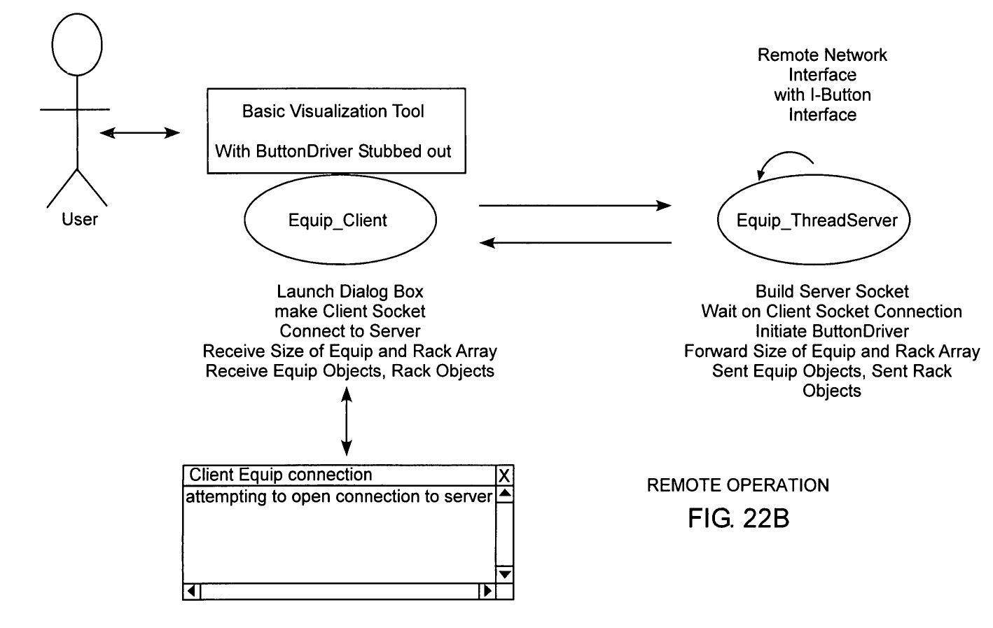

Other embodiments utilize an ordered expansion of the Visualization Tool, as an architecture, to a full network capability, where by way of example multiple individual I-Button network instances (each 300-meter, 500 I-Button), local and/or remote, are realized. Referring to FIG. 22A, an example visualization tool system 2200 provides such expanded capability. In this example embodiment, the visualization tool system 2200 includes a Visualization Tool 2202, one or more inventory databases 2204, Network Interfaces 2206 (including I-Button Adapters), I-Buttons 2208, and 1-Wire Couplers 2210 configured as shown. In this example embodiment, each of the Network Interfaces 2206 includes both Ethernet and I-Button interfaces. It should be appreciated however that the interface between the Visualization Tool 2202 and the other components of the visualization tool system 2200 can be wired or wireless, and can take the form of mechanisms other than an Ethernet interface. Electronic tagging devices other than the I-Buttons 2208 can also be employed.

In an example embodiment, the Network Interfaces 2206 are provided with Tiny InterNet Interfaces (TINI) (TINI® registered to Dallas Semiconductor Corporation) available from Maxim/Dallas Semiconductor Corp. The TINI is a standalone programmable Microcontroller with both Ethernet and I-Button interfaces, and has the physical form factor of a RAM SIMM card. The TINI also has its own Java Virtual Machine (JVM) and programmable non-volatile memory. This allows for programs written in Java (as in the standalone Visual Tool) to be ported and rehosted for execution on the TINI. Referring to FIG. 22B, in an example embodiment, the TINI hosts the Visual Tool ButtonDriver, Equip class, Rack Class and Equip_ThreadServer class and reports current I-Button configurations over a TCP/IP socket connection to the Visual Tool. The Visual Tool can be the same Visual Tool described earlier but with the ButtonDriver class stubbed out and an Equip_Client put in its place. In an example embodiment, the Equip_Client class contacts the Equip_ThreadServer class that is running on the remote network interfaces using the IP address of a remote network interface and socket ‘5432’. The Visual Tool receives the necessary Equip and Rack objects from the remote interface using Equip_Client. In this example, Equip_Client launches a Dialog box (as shown) to indicate to the operator when this communication is active. In an example embodiment, the TINI itself is physically incorporated into the rack or system rack set to which it is monitoring, consuming no more then a single U height. The Visual tool discerns the different TINI, and their reported serialized ArrayList Equip and Rack streams, by their associated IP addresses. In this matter, the Visual Tool can extend its capabilities beyond a single I-Button network. In an example embodiment, a pairing scheme is enforced, where once a Database URL is opened only the corresponding IP Network TINI I-Button view will be shown. It should be appreciated that other combinations of views can also be provided.

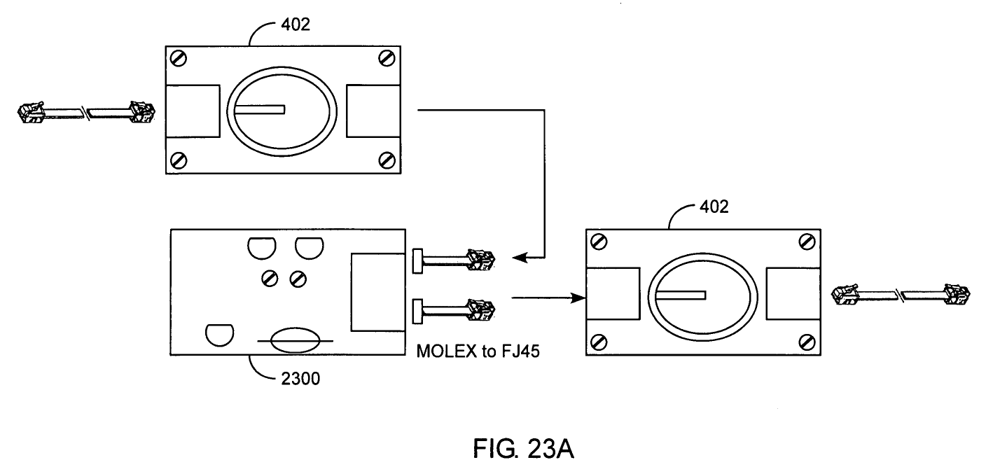

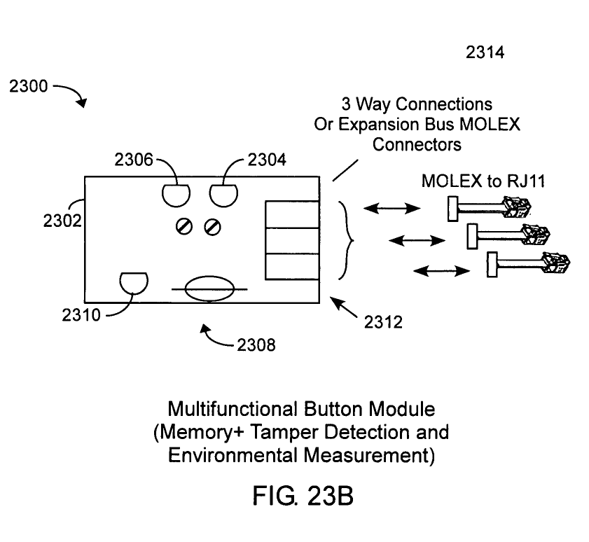

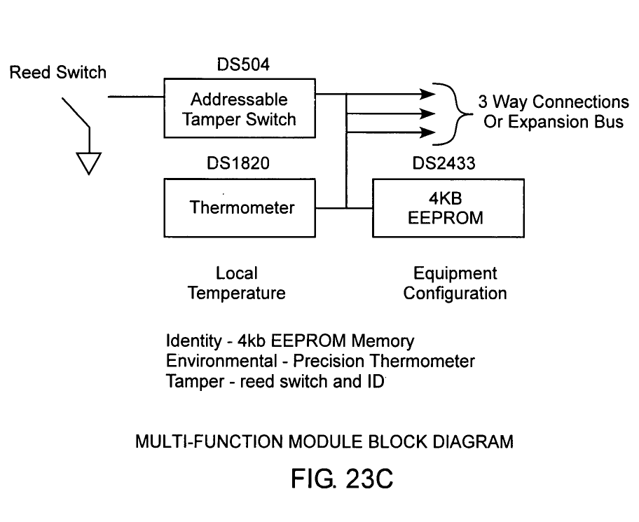

In addition to equipment configuration visualization, various embodiments also provide environmental monitoring functionality. By way of example, a multi-function module 2300 is shown in FIGS. 23A and 23B. This multi-function module 2300 operates as the I-Button memory module discussed above (e.g., interconnected with I-Button Fixtures 402 via MOLEX to RJ-45 as shown) but in addition supports other functionality, such as remote environmental sensing and tamper detection. In this example embodiment, the multi-function module 2300 uses 1-Wire technology. Referring to FIG. 23B, the multi-function module 2300 includes a multi-function fixture 2302 configured to operationally interconnect multiple sub-modules with external interfaces. In this example embodiment, the multi-function fixture 2302 is configured to receive and operatively interconnect a memory sub-module 2304, a thermometer sub-module 2306, a switch module 2308 (including an addressable tamper switch 2310), and external interface connectors 2312. By way of example, the multi-function module 2300 is mounted to equipment using double-sided tape. In this example embodiment, the sub-modules (or other components) are smaller in size than an I-Button such that a multi-function module as small as an I-Button fixture can be provided. In other embodiments, a multi-function module is smaller or larger than an I-Button fixture. It should also be appreciated that other types of sub-modules as well as other combinations of sub-modules can be used to provide a multi-function module.

By way of example, and referring also to FIG. 23C, the memory sub-module 2304 is an on-board 4 Kb EEPROM, which stores equipment configuration information. The thermometer sub-module 2306 includes a thermometer, which allows for environment temperature monitoring at discrete points within the laboratory or other equipment configuration. The switch module 2308 includes an addressable switch; an open or close condition allows for remote monitoring of tamper or intrusion. The switch module 2308 in this example embodiment includes an embedded switch, e.g., a magnetic reed switch, requiring a permanent magnet to be mounted between the multi-function module and the equipment to be tampering sensed. The Visual Tool software baseline works with the Multi-function module EEPROM in a manner similar to the I-Button memory with only a modification to the invoked class container within the JAVA code to register all components (e.g., 1-Wire components) corresponding to the functional elements of the multi-function module (the registry is created during multi-function module programming), and additional software to support the temperature and intrusion sensing system functions and displays.

In an example embodiment, an equipment configuration visualization apparatus includes a multi-function fixture including interfaces for sub-modules at least two of which are functionally different from each other, connectors for operatively interconnecting the multi-function fixture with external devices, and an electrical interface between the interfaces and the connectors.

Although the present invention has been described in terms of the example embodiments above, numerous modifications and/or additions to the above-described embodiments would be readily apparent to one skilled in the art. It is intended that the scope of the present invention extends to all such modifications and/or additions.

I claim:

1. An equipment configuration visualization apparatus comprising:
a visualization tool configured to integrate a network of electronic tagging devices that are directly and/or remotely interfaced with the visualization tool, the electronic tagging devices storing information associated with equipment, the visualization tool being configured to poll the electronic tagging devices to obtain the information and to generate visual representations from the information.

2. The equipment configuration visualization apparatus of claim 1, wherein the information includes an equipment location.

3. The equipment configuration visualization apparatus of claim 1, wherein the information identifies an equipment rack.

4. The equipment configuration visualization apparatus of claim 1, wherein the information includes an equipment rack position.

5. The equipment configuration visualization apparatus of claim 1, wherein the information includes an equipment rack size.

6. The equipment configuration visualization apparatus of claim 1, wherein the information includes an equipment identification number.

7. The equipment configuration visualization apparatus of claim 1, wherein the information includes an equipment model number.

8. The equipment configuration visualization apparatus of claim 1, wherein the information includes an equipment serial number.

9. The equipment configuration visualization apparatus of claim 1, wherein the information includes an equipment description.

10. The equipment configuration visualization apparatus of claim 1, wherein the visual representations include one or more equipment configuration views.

11. The equipment configuration visualization apparatus of claim 10, wherein the equipment configuration views include a network view of equipment discovered from polling the electronic tagging devices.

12. The equipment configuration visualization apparatus of claim 10, wherein the equipment configuration views include a database view of equipment generated from a database of known equipment configuration information.

13. The equipment configuration visualization apparatus of claim 1, wherein the visual representations include one or more rack drawings.

14. The equipment configuration visualization apparatus of claim 1, wherein the visualization tool is configured to compare network equipment configurations discovered from polling the electronic tagging devices with database equipment configurations.

15. The equipment configuration visualization apparatus of claim 1, wherein the visualization tool is configured to allow a user to program the electronic tagging devices with the information.

16. The equipment configuration visualization apparatus of claim 1, wherein the visualization tool is configured to allow a user to activate a graphical user interface from one or more of the visual representations.

17. An equipment configuration visualization method comprising:
securing electronic tagging devices to equipment;
remotely networking the electronic tagging devices;
polling the electronic tagging devices to retrieve equipment configuration information stored in the electronic tagging devices; and
generating visual representations from the equipment configuration information.

18. The equipment configuration visualization method of claim 17, wherein the visual representations include one or more equipment configuration views.

19. The equipment configuration visualization method of claim 18, wherein the equipment configuration views include a network view of equipment discovered from polling the electronic tagging devices.

20. The equipment configuration visualization method of claim 18, wherein the equipment configuration views include a database view of equipment generated from a database of known equipment configuration information.

21. The equipment configuration visualization method of claim 17, wherein the visual representations include one or more rack drawings.

22. The equipment configuration visualization method of claim 17, further including:
comparing network equipment configurations discovered from polling the electronic tagging devices with database equipment configurations.

23. The equipment configuration visualization method of claim 17, further including:
programming the electronic tagging devices with the equipment configuration information.

24. The equipment configuration visualization method of claim 17, further including:
activating a graphical user interface from one or more of the visual representations.

25. An equipment configuration visualization system comprising:
an interactive user interface that is networked to multiple storage devices secured to equipment, the interactive user interface being configured to allow a user to retrieve information from the storage devices and to automatically generate visual representations from the information.

26. The equipment configuration visualization system of claim 25, wherein the interactive user interface is implemented with Java Class components.

27. The equipment configuration visualization system of claim 25, wherein the interactive user interface is configured to allow the user to program the storage devices with the information.

28. The equipment configuration visualization system of claim 25, wherein the interactive user interface is configured to allow the user to provide inputs that cause the interactive user interface to generate one or more of the visual representations.

29. The equipment configuration visualization system of claim 25, wherein the visual representations include one or more graphical user interfaces.

30. The equipment configuration visualization system of claim 25, wherein the visual representations include one or more equipment configuration views.

31. The equipment configuration visualization system of claim 30, wherein the equipment configuration views include a network view of equipment discovered from polling the storage devices.

32. The equipment configuration visualization system of claim 30, wherein the equipment configuration views include a database view of equipment generated from a database of known equipment configuration information.

33. The equipment configuration visualization system of claim 25, wherein the visual representations include one or more rack drawings.

34. The equipment configuration visualization system of claim 25, wherein the visual representations include a comparison of network equipment configurations discovered from polling the storage devices with database equipment configurations.

35. An equipment configuration visualization apparatus comprising:
a fixture including an interface for an electronic tagging device, connectors for operatively interconnecting the fixture with external devices, and an electrical interface between the interface and the connectors.

36. The equipment configuration visualization apparatus of claim 35, further including:
a mechanism for securing the fixture to host equipment.

37. The equipment configuration visualization apparatus of claim 35, wherein the interface includes a coin cell battery holder.

38. The equipment configuration visualization apparatus of claim 35, wherein the connectors are configured for connecting the fixture to a network.

39. The equipment configuration visualization apparatus of claim 35, wherein the connectors are modular.

40. An equipment configuration visualization apparatus comprising:
a multi-function fixture including interfaces for sub-modules at least two of which are functionally different from each other, connectors for operatively interconnecting the multi-function fixture with external devices, and an electrical interface between the interfaces and the connectors.

41. The equipment configuration visualization apparatus of claim 40, wherein the sub-modules include a memory device for storing equipment configuration information.

42. The equipment configuration visualization apparatus of claim 40, wherein the sub-modules include a thermometer for environmental temperature monitoring.

43. The equipment configuration visualization apparatus of claim 40, wherein the sub-modules include an addressable switch for remote monitoring of a tamper or sense line.

44. The equipment configuration visualization apparatus of claim 40, further including:
a mechanism for securing the fixture to host equipment.

45. The equipment configuration visualization apparatus of claim 40, wherein the connectors are configured for connecting the multi-function fixture to a network.

46. The equipment configuration visualization apparatus of claim 40, wherein the connectors are modular.
